(19) United States
(12) Patent Application Publication
(10) Pub. No.: US 2008/0216788 A1
(43) Pub. Date: Sep. 11, 2008

(54) Arrangement for operating an internal combustion engine

(76) Inventors: Christian Henrich, Ebersbach (DE); Rolf Klenk, Fellbach (DE); Norbert Merdes, Heidellberg (DE); Oliver Schrems, Stuttgart (DE); Klaus Wunderlich, Waiblingen (DE)

Correspondence Address: KLAUS J. BACH, 4407 TWIN OAKS DRIVE, MURRYSVILLE, PA, 15668, US

(21) Appl. No.: 12/009,848

(22) Filed: Jan. 22, 2008

Related U.S. Application Data
(63) Continuation-in-part of application No. PCT/EP2006/006710, filed on Aug. 7, 2006.

(30) Foreign Application Priority Data
Jul. 22, 2005 (DE) 10 2005 034 274.4

(51) Int. Cl. F02M 35/108; F02D 9/02; F02B 33/00

(52) U.S. Cl. 123/184.56; 123/184.52; 123/562

(57) ABSTRACT

In an arrangement and method for operating an internal combustion engine with at least two intake pipe tracts connected each to one group of cylinders, with each of the intake pipe tracts including at least one independently adjustable throttle element for controlling the intake air pressures in the respective intake pipe tract, at least one pressure equalizing means is provided for equalizing the intake pipe pressures in at least one operating mode under the control of a control unit which actuates the throttle element and the pressure equalizing means depending on the engine operating state.

This is a Continuation-In-Part application of pending international patent application PCT/EP2006/006710 filed Jul. 8, 2006 and claiming the priority of German Patent Application 10 2005 034 274.4 filed Jul. 22, 2007.

### BACKGROUND OF THE INVENTION

The invention relates to an arrangement and a method for operating an internal combustion engine including at least two intake ducts leading to different groups of cylinders and having independently adjustable throttle elements for adjusting the combustion gas pressure in the intake duct.

DE 101 48 347 A1 discloses a device having a unit for actuating an internal combustion engine with at least two intake pipe tracts extending to different groups of cylinders. Each of the intake pipe tracts is assigned at least one independently adjustable throttle element for adjusting the intake pipe pressure of the respective intake pipe tract.

It is the principal object of the present invention to provide a device which prevents an inadvertent difference between the intake pipe pressures in different intake ducts leading to different cylinder groups of an engine. Tolerances of the throttle elements and differences in the intake pipe tracts should also be equalized at least in some operating modes.

### SUMMARY OF THE INVENTION

In an arrangement and method for operating an internal combustion engine with at least two intake pipe tracts connected each to one group of cylinders, with each of the intake pipe tracts including at least one independently adjustable throttle element for controlling the intake air pressures in the respective intake pipe tract, at least one pressure equalizing means is provided for equalizing the intake pipe pressures in at least one operating mode under the control of a control unit which actuates the throttle element and the pressure equalizing means depending on the engine operating state.

It is proposed that the device comprises at least one pressure equalizing means for equalizing the intake pipe pressures in at least one operating mode. In this way, it is possible to obtain pressure equalization between the intake pipe tracts in the operating mode if desired. Pressure differences which could result for example from tolerances in the throttle elements or from asymmetrical charge conditions can be avoided by means of the pressure equalization.

Although the device according to the invention can in principle be used in connection with any internal combustion engine which would appear to a person skilled in the art to be expedient, the gain in comfort as a result of improved running smoothness of the engine can be clearly perceived in particular in connection with motor vehicle engines.

The group of cylinders assigned to an intake pipe tract can comprise any number of cylinders which would appear to a person skilled in the art to be expedient. For reasons of running smoothness, it is particularly advantageous for three or more cylinders whose ignition times are distributed uniformly over a working cycle of the internal combustion engine to be combined to form a group. The cylinders of a group can be situated on one cylinder bank or can also be distributed over two cylinder banks.

If the pressure equalizing means is embodied as a pressure equalizing passage between the at least two intake pipe tracts, it is possible to obtain a direct and fast pressure equalization. The pressure equalization can be permitted or prevented in a targeted fashion in certain phases by means of a controllable closure flap for opening and closing the pressure equalizing passage. In principle, embodiments of the invention are also conceivable in which the pressure equalization takes place indirectly by means of a control circuit.

If at least one of the groups of cylinders can be deactivated, it is possible by means of the pressure equalizing means according to the invention to combine the advantages of the deactivatable cylinders with a symmetrical load in full-load engine operation. In principle, however, motor vehicle engines which have a plurality of independent intake pipe tracts and throttle elements and which comprise no deactivatable group are also conceivable.

Differences in the intake pipe pressures caused by differences or tolerances between supercharging devices can be eliminated by means of the pressure equalizing means according to the invention if in each case one independent supercharging device for increasing the intake pipe pressure is assigned to the at least two intake pipe tracts. Consideration is given in particular to a compressor or a turbocharger as a supercharging device.

Tolerances of the throttle elements can advantageously be equalized by the pressure equalizing means if the unit is provided to generate a pressure equalization between the intake pipe tracts by opening the pressure equalizing means when the intake pipe pressures in both intake pipe tracts are throttled intensely by the throttling elements and both groups of cylinders are operated with the same load. In this context, “provided” should also be understood to mean “designed” and “equipped”. “Throttled intensely by one of the throttle elements” is intended to refer to an intake pipe pressure when the intake pipe pressure lies in a value range which corresponds to an engine load below 30% of full load.

Further advantages can be obtained if the unit is provided to generate pressure equalization between the intake pipe tracts by opening the pressure equalizing means, and when a load demand of the internal combustion engine exceeds a threshold value. In this way, differences between the intake air ducts, which are particularly apparent close to full load operation of the internal combustion engine, can be minimized.

If the unit is provided to generate a pressure equalization between the intake pipe tracts by opening the pressure equalizing means when the at least two groups of cylinders are in equal operation, it is possible to reliably pre-vent undesired pressure differences. Here, “equal operation” is intended to refer in particular to operating modes in which the groups of cylinders which are connected to the intake pipe tracts generate an equal torque, or operating modes in which an equal pressure level is required in the intake pipe tracts. It is also possible in equal operation, and specifically under full load, to the pressure waves of the two intake systems or intake pipe tracts for a passive increase in the cylinder charge, in particular when the two groups of cylinders are actuated in a phase-offset manner. Intake pipe registering is then possible under full load.

The invention also resides in a method for actuating an internal combustion engine having at least two intake pipe tracts which are assigned in each case to one group of cylinders, with each of the intake pipe tracts including at least one independently adjustable throttle element in order to adjust an intake pipe pressure of the respective intake pipe tract.

It is proposed that, in at least one operating mode, at least one pressure equalizing means is opened in order to equalize the intake pipe pressures. It is possible in this way to prevent an undesired pressure difference between the intake pipes in the corresponding operating mode.

In one refinement of the method according to the invention, the pressure equalizing means is opened in order to generate a pressure equalization between the at least two intake pipe tracts when the at least two groups of cylinders are operated with the same load.

The invention will become more readily apparent from the following description of exemplary embodiments thereof on the basis of the accompanying drawings:

### BRIEF DESCRIPTION OF THE DRAWINGS

FIG. 1 shows an internal combustion engine having two intake pipe tracts and having two supercharging devices,

FIG. 2 shows an alternative internal combustion engine having two intake pipe tracts without supercharging devices, and

FIG. 3 shows a graph which describes a dependency of an effective consumption of the internal combustion engine from FIGS. 1 and 2 on a mean effective pressure.

### DESCRIPTION OF PARTICULAR EMBODIMENTS

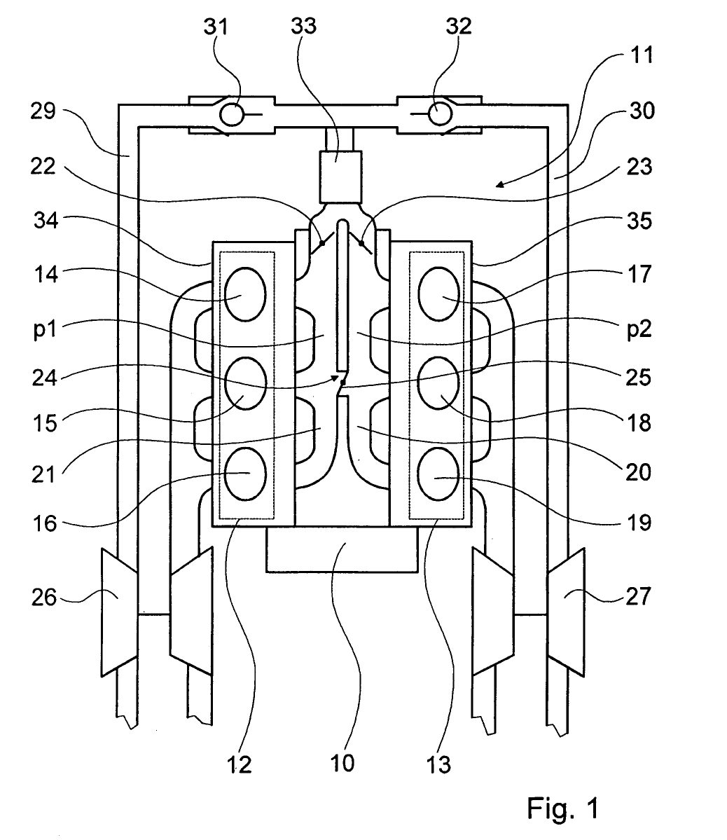

FIG. 1 shows an internal combustion engine 11 in the form of a six-cylinder motor vehicle engine with two supercharging devices 26, 27 in the form of turbochargers. The supercharging devices 26, 27 increase a charge pressure in two intake air pipes 29, 30 over an ambient air pressure. Intake air flows through in each case one valve 31, 32 arranged in the intake air pipes 29, 30 and passes through an air mass sensor 33 into one of two parallel intake pipe tracts 20, 21 which are arranged mirror-symmetrically between two cylinder banks 34, 35. The valves 31, 32 can be embodied in a way which would appear to a person skilled in the art to be expedient, for example as a non-return valve or as a switchable valve.

Arranged in an inlet region of the intake pipe tracts 20, 21 is in each case one separate, independently controllable throttle element 22, 23, specifically a throttle flap.

A programmable unit 10 which is a control unit operates the internal combustion engine 11 and is connected to a CAN bus (not illustrated) of a motor vehicle which comprises the internal combustion engine 11. In addition, the unit 10 is connected by means of control lines to actuators (not illustrated explicitly here) for controlling the throttle elements 22, 23 and a closure flap 25.

The cylinder bank 34 comprises three cylinders 14-16 which form a first group 12 of cylinders 14-16, and the second cylinder bank 35 comprises three further cylinders 17-19 which form a second group 13 of cylinders 17-19. The first group 12 of cylinders 14-16 is connected to the first intake pipe tract 21 and the second group 13 of cylinders 17-19 is connected to the second intake pipe tract 20.

Both groups 12, 13 of cylinders 14-16, 17-19 can be activated and deactivated by the control unit 10. In order to deactivate a group 12, 13, the unit 10 sets the valve lifts of the inlet and outlet valves of the cylinders 14-16, 17-19 of the group 12 or 13 which is to be deactivated to zero by means of actuating elements (not illustrated explicitly here), and closes the respective throttle element 22, 23 of the intake pipe tract 20, 21 which is connected to the cylinders 14-16, 17-19 of the corresponding groups 12, 13. The valves 31, 32 prevent a return flow of air through the respective intake air pipe 29, 30 into the supercharging device 26, 27 assigned to the deactivated group 12, 13.

Formed between the two intake pipe tracts 20, 21 is a pressure equalizing means 24, which is a pressure equalization passage, for equalizing the intake pipe pressure p1, p2 which are present in the intake pipe tracts 20, 21. The pressure equalizing means 24 can be opened and closed by the closure flap 25 which can be controlled by the unit 10. The intake pipe pressures p1, p2 are determined by the work of the supercharging devices 26, 27 and by the throttling action of the throttle elements 22, 23. When the closure flap 25 and therefore the pressure equalizing means 24 are opened, the values of the intake pipe pressures p1, p2 are quickly equalized, while the values of the intake pipe pressures p1, p2 can be different when the closure flap 25 is closed.

If the intake pipe pressures p1, p2 are different, a different mixture quantity flows into the cylinders 14-19 of the two groups 12, 13, so that the two cylinder banks 34, contribute different torques to an overall torque of the internal combustion engine 11. The torque contributions are determined by the unit 10 based on the position of the throttle elements 22, 23, specifically as a function of a throttle pedal angle which can be set by a driver of the motor vehicle. The intake pipe pressures p1, p2 determine a charge quantity of the cylinders 14-19.

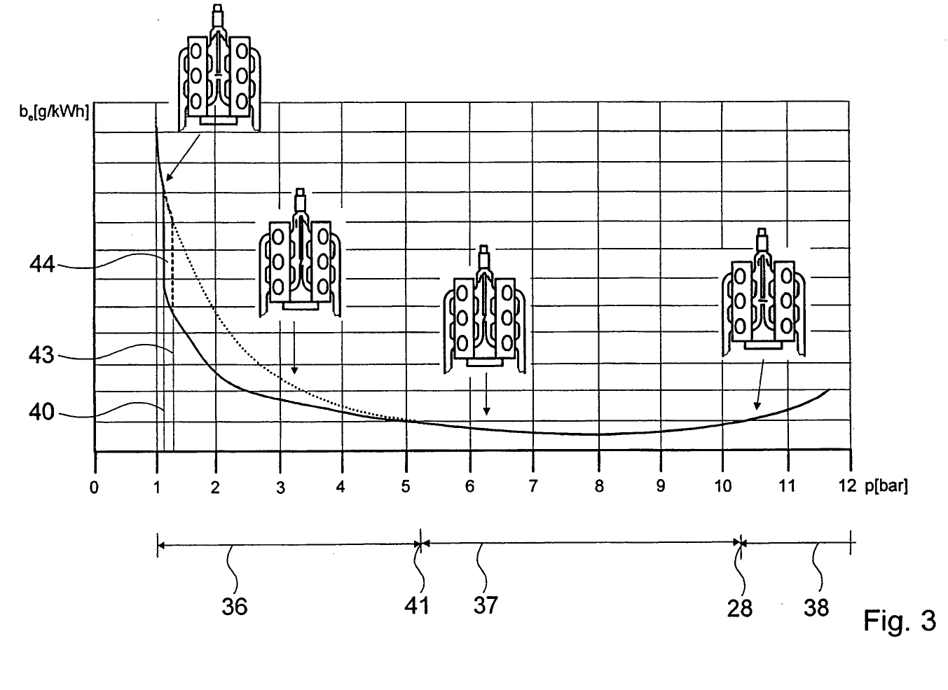

FIG. 3 represents a graph which shows different load ranges 36-38 of the internal combustion engine 11 and in which an effective consumption bₑ is plotted against a mean effective pressure p. The mean effective pressure p, which is plotted on the abscissa, is proportional to a torque generated by the internal combustion engine 11 after the subtraction of all losses. The dotted line describes the consumption bₑ without cylinder deactivation, the solid line shows the profile of the consumption bₑ with cylinder deactivation, wherein in a hysteresis range 44, the profile during a rising load demand is indicated by a dashed line. In idle operation, the unit 10 operates the two groups 12, 13 of cylinders 14-19 symmetrically, that is to say with equal throttle flap nominal position, and with the pressure equalizing means 24 open.

In a first load range 36, the unit 10 deactivates one of the groups 12, 13 of cylinders 14-19 and generates the entire demanded torque by means of the in respective other group of cylinders 14-19. The pressure equalizing means 24 must therefore remain closed in the first load range 36. Which of the groups 12, 13 is deactivated is determined by the unit 10 according to an alternating algorithm in each case at the start of a phase with cylinder deactivation.

If the load demand, proceeding from a relatively high value, reaches a rotational-speed-dependent activation load threshold 40 in a low-load range, the unit 10 activates the second of the two cylinder banks 34, 35. For this purpose, the unit 10 opens the closure flap 25 of the pressure equalizing means 24 in order to directly provide the correct pressure ratio in both intake pipe tracts 20, 21, and thereby prevent an uncomfortable and noticeable jerk, when activating the previously deactivated group 12, 13 of cylinders 14-19.

If the load demand, proceeding from a relatively low value, reaches a rotational-speed-dependent deactivation load threshold 43, the unit 10 deactivates one of the two cylinder banks 34, 35. The consumption varies here according to the dashed line illustrated in FIG. 3. Provided between the deactivation load threshold 43 and the activation load threshold 40, which always lies below the deactivation load threshold 43, is a hysteresis region 44, by means of which oscillating switching is avoided.

The deactivation load threshold 43 and the activation load threshold 40 are stored as rotational-speed dependent characteristic curves in a memory of the control unit 10.

In a second load range 37, the unit 10 operates the group 12, 13 of cylinders 14-19 which is active in the first load range 36 with a constant, optimum-consumption torque, and generates a torque difference between the optimum-consumption torque and a demanded nominal torque by means of the in each case other, variable group 12, 13 of cylinders 14-19. In the second load range 37, too, the pressure equalizing means 24 remains closed.

The air mass measured by the air mass sensor 33 at the transition from the first load range 36 to the second load range 37 is stored as a set-point variable together with all other combustion-relevant characteristic variables such as for example ignition angles and camshaft positions. The unit 10 determines the air mass supplied to the variable group 12, 13 of cylinders 14-19 in the second load range 37 by forming the difference between the air mass measured by the air mass sensor 33 and the stored set-point mass.

In an alternative embodiment of the invention, the intake air pipes 29, 30 are guided into the intake pipe tracts 20, 21 without first being merged, and have in each case separate air mass measurement.

In the third load range 38, the unit 10 operates both groups 12, 13 equally and with the pressure equalizing means 24 open, and as a result always generates a pressure equalization in the event of a load demand above a threshold value 28. In the region of a transition between the second load range 37 and the third load range 38, the intake pipe pressures p1, p2 are throttled intensely by the throttle elements 22, 23.

Any pressure differences which may be caused by tolerances of the throttle elements 22, 23 are therefore equalized by the pressure equalizing means 24 in the operating mode which is characterized by the load demand present in the third load range 38. In one end region of the third load range 38, the pressure equalizing means 24 equalizes primarily differences between the conditions in the two intake pipe tracts 20, 21 caused by differences in the supercharging devices 26, 27 and/or air guiding tolerances.

A first switchover point 41 which separates the first load range 36 from the second load range 37 is stored as a rotational-speed dependent characteristic curve in a memory unit of the unit 10.

A second switchover point which separates the second load range 37 from the third load range 38 is likewise stored as a function of rotational speed and in a characteristic curve, with it being possible in a further embodiment of the invention for the second switchover point to be determined by the unit 10 in that, at the second switchover point, the intake pipe pressures p1, p2 or the positions of the throttle elements 22, 23 have the same value. The second switchover point between the second load range 37 and the third load range 38 therefore forms the threshold value 28 of a load demand of the internal combustion engine 11.

In the region of full load, it is possible by opening or closing the closure flap 25 to influence resonance excitations in the system of the intake pipe tracts 20, 21, as a result of which a cylinder charge can be further improved. The pressure equalizing means 24 can therefore also be utilized for intake pipe registering in particular under full load.

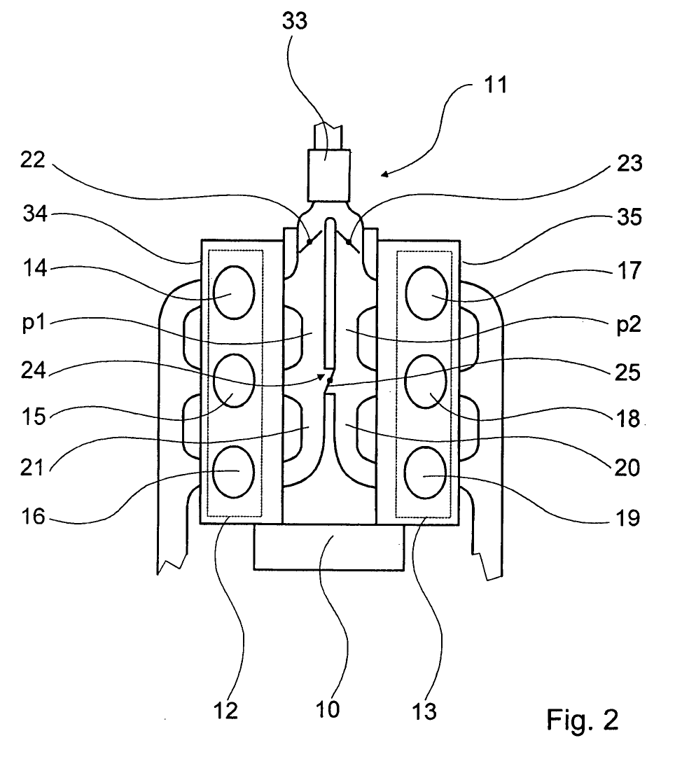

FIG. 2 shows an alternative internal combustion engine 11 with two throttle elements 22, 23 and two intake pipe tracts 20, 21. In contrast to the internal combustion engine 11 illustrated in FIG. 1, the internal combustion engine 11 in FIG. 2 has no supercharging device and no switchable valve or non-return valve. With regard to the remaining features, which are largely analogous to the features from FIG. 1 and are therefore provided with the same reference symbols, reference can be made to the description with regard to FIG. 1. In the non-charged internal combustion engine 11 in FIG. 2, the pressure equalizing means 24 serves to equalize intake pipe pressure differences which can be generated by different intake paths or intake resistances.

What is claimed is:

1. An arrangement for operating an internal combustion engine (11) having at least two groups (12, 13) of cylinders (14-19) with at least two intake pipe tracts (20, 21) each being assigned to one group (12, 13) of cylinders (14-19), with each of the intake pipe tracts (20, 21) having at least one independently adjustable throttle element (22, 23) for adjusting an intake pipe pressure (p1, p2) of the respective intake pipe tract (20, 21), at least one pressure equalizing means (24) for equalizing the intake pipe pressures (p1, p2) in at least one operating mode, and a control unit (10) for controlling the actuation of the throttle elements (22, 23) and the pressure equalizing means depending on an operating state of the engine.

2. The arrangement as claimed in claim 1, wherein the pressure equalizing means (24) is a pressure equalizing passage extending between the at least two intake pipe tracts (20, 21).

3. The arrangement as claimed in claim 2, wherein a controllable closure flap (25) is disposed in the passage (24) for opening and closing the pressure equalizing passage (24).

4. The arrangement as claimed in claim 1, wherein at least one of the groups (12, 13) of cylinders (14-19) is deactivatable while the engine is operating with only the other group.

5. The arrangement as claimed in claim 1, wherein an independent supercharging device (26, 27) for increasing the intake pipe pressure (p1, p2) is assigned to each of the intake pipe tracts (20, 21).

6. The assignment as claimed in claim 1, wherein the control unit (10) is adapted to provide for a pressure equalization between the intake pipe tracts (20, 21) by opening the pressure equalizing means (24) when the intake pipe pressures (p1, p2) in both intake pipe tracts (20, 21) are throttled intensely by the throttling elements (22, 23) and both groups (12, 13) of cylinders (14-19) are operated with the same load.

7. The arrangement as claimed in claim 1, wherein the control unit (10) is adapted to provide for pressure equalization between the intake pipe tracts (20, 21) by opening the pressure equalizing passage (24) when a load demand of the internal combustion engine (11) exceeds a threshold value (28).

8. The arrangement as claimed in claim 1, wherein the control unit (10) is adapted to provide for a pressure equalization between the intake pipe tracts (20, 21) by opening the pressure equalizing passage (24) when the at least two groups (12, 13) of cylinders (14-19) are in equal operation.

9. A method for operating an internal combustion engine (11) having at least two intake pipe tracts (20, 21) each of which includes a group (12, 13) of cylinders (14-19), with each of the intake pipe tracts (20, 21) having at least one independently adjustable throttle element (22, 23) for adjusting an intake pipe pressure (p1, p2) of the respective intake pipe tract (20, 21), said method comprising the step of
in at least one operating mode, opening at least one pressure equalizing passage (24) for equalizing the intake pipe pressures (p1, p2) in the at least two intake pipe tracts (20, 21).

10. The method as claimed in claim 9, wherein a pressure equalizing passage (24) extends between the intake pipe tracts (20, 21) and this passage (20, 21) is opened in order to generate a pressure equalization between the at least two intake pipe tracts (20, 21) when the at least two groups (12, 13) of cylinders (14-19) are operated with the same load.
